(19) United States
(12) Patent Application Publication
(10) Pub. No.: US 2010/0074449 A1
(43) Pub. Date: Mar. 25, 2010

(54) RECORDER AND RECORDING METHOD

(76) Inventor: Kazumasa Tabata, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/513,374

(22) PCT Filed: Oct. 30, 2007
(86) PCT No.: PCT/JP2007/071141

§ 371 Date: May 4, 2009

(30) Foreign Application Priority Data
Nov. 7, 2006 (JP) 2006-301161

(51) Int. Cl. H04R 5/00

(52) U.S. Cl. 381/1

(57) ABSTRACT

To provide a recorder and other means for recording an audio signal of good quality with continuity maintained.

A recorder can record multichannel audio signals by switching one of multiple types of microphones to another. The microphones include first and second types of microphones for first and second numbers of channels. One of the first and second types is removable from and attachable to the recorder. The recorder includes: a signal processing section that receives the multichannel audio signals and record them on a storage medium; and a switching control section for controlling a signal path such that on sensing the removable/attachable microphones be removed or attached while audio signals picked up by the first type of microphones are being recorded, audio signals in the same number of channels as the first number, including at least one audio signal picked up by the second type of microphones, are sent to the signal processing section, which receives the audio signals in the same number of channels as the first number through the signal path and records them on the storage medium.

### TECHNICAL FIELD

The present invention relates to a recorder that can record multichannel audio signals on a storage medium. More particularly, the present invention relates to a recorder that can switch multiple types of microphones and store an audio signal, picked up by any of those microphones, on a storage medium.

### BACKGROUND ART

Recently, as the performance of camcorders has been improved significantly, 5.1 channel (CH) surround sound can now be recorded often as for an audio signal picked up by a microphone, too.

A camcorder records such 5.1ch surround sound in the following manner. Specifically, audio signals picked up by a 5ch internal microphone assembly are encoded as it is by an AC-3 codec and 0.1ch audio signal, which forms the bass portion of the audio signals that have come from the 5ch internal microphone assembly, is also encoded. As a result, digitized audio signals in six different channels in total can be obtained. The audio signals thus obtained are stored on a DVD, a memory card or any other suitable storage medium.

A 5ch internal microphone assembly provided for a camcorder has the function of picking up a variety of sounds coming from around the camcorder. With such a function, however, it is sometimes not easy to catch a sound that has come far away from the camcorder or a sound of the voice of a person being interviewed, for example. Thus, to compensate for such inconveniences, external microphones can be used effectively. For that reason, nowadays some camcorders have a jack to plug in a 2ch external microphone assembly.

For example, Patent Document No. 1 discloses an audio recorder that can selectively use internal microphones and external microphones and also teaches how a recording operation should be performed when the microphones are switched from the internal ones into the external ones.

Specifically, the audio recorder of Patent Document No. 1 includes: detecting means for sensing that external microphones have been plugged into the recorder; selecting means for selecting either audio signals that have come from internal microphones or ones that have come from the external microphones; setting means for setting either a monaural sound recording mode or a stereo sound recording mode; and audio recording means. In accordance with signals supplied from the detecting means, selecting means and setting means, either the audio signals that have come from the external microphones or the ones that have come from the internal microphones are selected and recorded by the audio recording means.
Patent Document No. 1: Japanese Patent Application Laid-Open Publication No. 2004-347998

### DISCLOSURE OF INVENTION

### Problems to be Solved by the Invention

If the microphones to pick up the audio signal were changed from the 5ch internal microphone assembly into the 2ch external one while the audio signal is being recorded, the recording methods should also be changed from the 5.1ch surround sound recording into the 2ch stereo sound recording. In that case, however, the audio signals recorded would become discontinuous.

On top of that, some of various audio recording formats prohibit changing the recording methods from the 5.1ch surround sound recording into the 2ch stereo sound recording, or vice versa, within a single piece of recorded data.

It is therefore an object of the present invention to provide a recorder and recording method that can record an audio signal of good quality with continuity maintained.

### Means for Solving the Problems

A recorder according to the present invention can record multichannel audio signals by switching one of multiple types of microphones to another. The multiple types of microphones include a first type of microphones for a first number of channels and a second type of microphones for a second number of channels. One of the first and second types of microphones is removable from and attachable to the recorder. The recorder includes: a signal processing section that receives the multichannel audio signals and record the signals on a storage medium; and a switching control section for controlling a signal path such that on sensing the removable/attachable microphones be removed from or attached to the recorder while audio signals that have been picked up by the first type of microphones are being recorded, audio signals in the same number of channels as the first number, including at least one audio signal that has been picked up by the second type of microphones, are sent to the signal processing section. The signal processing section receives the audio signals in the same number of channels as the first number through the signal path and records the audio signals on the storage medium.

The first type of microphones may be built in the recorder and the second type of microphones may be connected to, but removable from and attachable to the recorder.

Alternatively, the first type of microphones may be connected to, but removable from and attachable to the recorder and the second type of microphones may be built in the recorder.

If the first number of channels is greater than the second number of channels, then the switching control section may control the signal path such that audio signals in the same number of channels as the first number, including the audio signals that have been picked up by the second type of microphones and a mute audio signal, are sent to the signal processing section.

On the other hand, if the first number of channels is smaller than the second number of channels, then the switching control section may control the signal path such that audio signals in the same number of channels as the first number, which have been selected from the audio signals that have been picked up by the second type of microphones, are sent to the signal processing section.

The switching control section may sense the second type of microphones be attached to the recorder while the audio signals that have been picked up by the first type of microphones are being recorded.

The switching control section may also sense the first type of microphones be removed from the recorder while the audio signals that have been picked up by the first type of microphones are being recorded.

After audio has stopped being recorded, the switching control section may control the signal path such that the audio signals in the second number of channels, which have been picked up by the second type of microphones, are sent to the signal processing section.

A recording method according to the present invention is carried out with a recorder that can record multichannel audio signals by switching one of multiple types of microphones to another. The multiple types of microphones include a first type of microphones for a first number of channels and a second type of microphones for a second number of channels. One of the first and second types of microphones is removable from and attachable to the recorder. The method includes the steps of: receiving the multichannel audio signals and recording the signals on a storage medium; sensing the removable and attachable microphones be removed from, or attached to, the recorder while audio signals that have been picked up by the first type of microphones are being recorded; controlling a signal path on sensing the microphones be removed or attached to output audio signals in the same number of channels as the first number including at least one audio signal that has been picked up by the second type of microphones; and recording the audio signals in the same number of channels as the first number on the storage medium.

### EFFECTS OF THE INVENTION

According to the present invention, if a change of microphones is sensed while an audio signal is being recorded with a first type of microphones, which is designed to pick up audio signals in a first number of channels, then audio signals in the same number of channels as the first number, including at least one audio signal that has been picked up by a second type of microphones designed to pick up audio signals in a second number of channels, are recorded on a storage medium. As a result, as for the channels in the same number as the first number, the audio signal never becomes discontinuous even during the change and can maintain its continuity.

For example, even if the microphones are changed into a 2ch external microphone assembly while audio signals that have been picked up by a 5ch internal microphone assembly are being recorded or even if the microphones are changed into the 5ch internal microphone assembly while audio signals that have been picked up by the 2ch external microphone assembly are being recorded, the audio signals on the two main channels never get discontinued even during the change but can maintain its continuity. In addition, no extra signals are recorded on any other channel but the two main ones.

On top of that, according to the present invention, the number of channels for recording remains the same before and after a change of microphones. That is why even if a given audio recording format prohibits changing the numbers of channels for recording within a single piece of data being recorded, the audio signal can still be recorded compliant with such an audio recording format.

### BRIEF DESCRIPTION OF DRAWINGS

FIG. 1 illustrates the appearance of a camcorder 100 as a preferred embodiment of the present invention.

FIG. 2 illustrates an arrangement of circuit blocks in the camcorder 100 according to the preferred embodiment of the present invention.

FIG. 3 shows the timings to switch the audio signals when the microphones to use are changed from the 5ch internal microphone assembly into the 2ch external microphone assembly.

FIG. 4 is a flowchart showing the procedure of the processing steps to be done if the microphones are changed into the 2ch external microphone assembly 2 while audio is being recorded with the 5ch internal microphone assembly 1.

FIG. 5 shows the timings to switch the audio signals when the microphones to use are changed from the 2ch external microphone assembly into the 5ch internal microphone assembly.

FIG. 6 is a flowchart showing the procedure of the processing steps to be done if the microphones are changed into those of the 5ch internal microphone assembly 1 while audio is being recorded with the 2ch external microphone assembly 2.

### DESCRIPTION OF REFERENCE NUMERALS

1 5ch internal microphone assembly
2 2ch external microphone assembly
3 external microphone plug
4 external microphone jack
5 microphone plug sensor switch
6 front microphone selector switching unit
7 central/rear microphone selector switching unit
8 microcomputer
9 noise filter A/D converter
10 AC-3 codec
20 recording start/stop switch
23 H. 264 codec
24 signal processor
25 memory card slot
26 storage medium
100 camcorder

### BEST MODE FOR CARRYING OUT THE INVENTION

Hereinafter, preferred embodiments of a recorder according to the present invention will be described with reference to the accompanying drawings.

### Embodiment 1

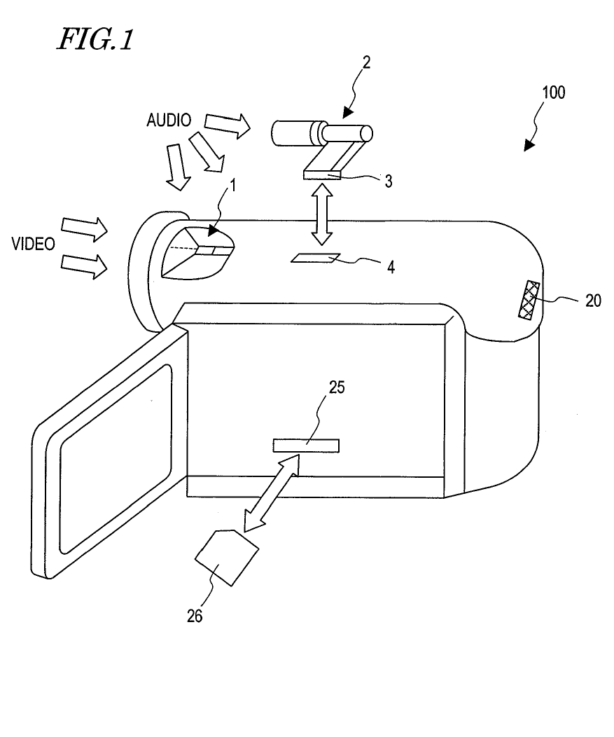

FIG. 1 illustrates the appearance of a camcorder 100 as a preferred embodiment of the present invention. The camcorder 100 can capture video and audio as data and store them as video information and audio information on a storage medium 26.

The camcorder 100 has a shooting start/stop switch 20 and a memory card slot 25. When the user turns the switch 20 with the storage medium 26 inserted in advance into the memory card slot 25, the camcorder 100 starts recording video and audio. But when the user turns the switch 20 again, the camcorder 100 will stop recording.

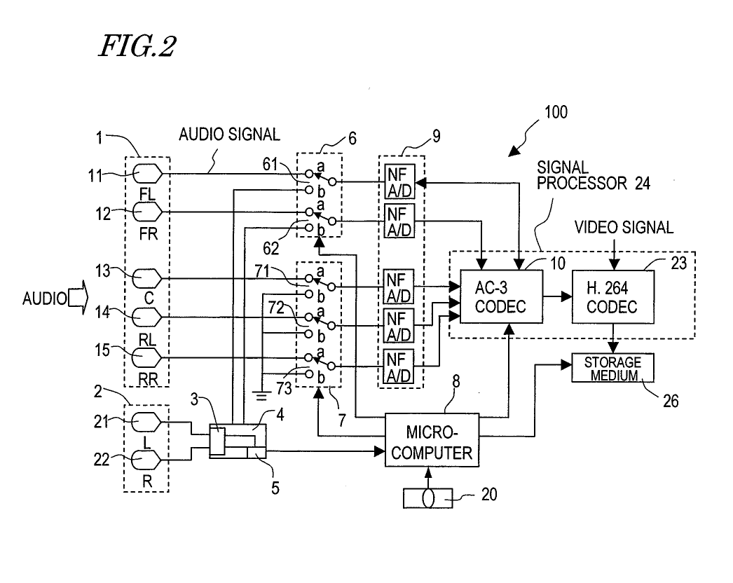

The video and audio are picked up by an imaging optical system (not shown) and a microphone 1 that are provided for the camcorder 100. The microphone 1 is built in right under the top of the camcorder 100 and is actually made up of a number of microphones. Those microphones that form the microphone 1 will be described in detail later with reference to FIG. 2.

The camcorder 100 also has an external microphone jack 4, which is used to connect an external microphone assembly 2 that is provided separately from the camcorder 100. By inserting an external microphone plug 3 of the external microphone assembly 2 into the external microphone jack 4, the external microphone assembly 2 and the camcorder 100 can get connected together. As a result, the camcorder 100 gets ready to record the audio that has been picked up by the external microphone assembly 2. On the other hand, when the external microphone assembly 2 is removed from the camcorder 100, the camcorder 100 will get ready to record the audio that has been picked up by the internal microphone assembly 1. Optionally, while the external microphone assembly 2 is attached, the user may be allowed to select either the internal microphone assembly 1 or the external microphone assembly 2.

It should be noted that the microphone assembly 1 will be referred to herein as the “internal microphone assembly 1” as opposed to the external microphone assembly 2.

FIG. 2 illustrates an arrangement of circuit blocks in the camcorder 100 of this preferred embodiment. In FIG. 2, the external microphone assembly 2 is supposed to be attached and the storage medium 26 is also illustrated for convenience sake.

The camcorder 100 includes the internal microphone assembly 1, the external microphone jack 4, a front microphone selector switching unit 6, a central/rear microphone selector switching unit 7, a microcomputer 8, noise filters and A/D converters 9, a recording start/stop switch 20 and a signal processor 24.

Hereinafter, these components will be described one by one.

The microphone 1 consists of a front left (FL) microphone 11, a front right (FR) microphone 12, a central (C) microphone 13, a rear left (RL) microphone 14 and a rear right (RR) microphone 15. The FL microphone 11 picks up sounds coming from the front left hand side. The FR microphone 12 picks up sounds coming from the front right hand side. The C microphone 13 picks up sounds coming from the front side. The RL microphone 14 picks up sounds coming from the rear left hand side. And the RR microphone 15 picks up sounds coming from the rear right hand side. These microphones 11 through 15 output audio signals representing the sounds picked up. As a result, audio signals in five channels can be obtained with this microphone 1.

Meanwhile, the external microphone assembly 2 consists of just a left (L) microphone 21 and a right (R) microphone 22. The L microphone 21 picks up sounds coming from the front left hand side, while the R microphone 22 picks up sounds coming from the front right hand side. Using this external microphone assembly 2, audio signals in two channels can be obtained.

The external microphone jack 4 includes a microphone plug sensor switch 5 (which will be simply referred to herein as a “sensor switch 5” and), which senses the 2ch external microphone assembly 2 be attached or removed to/from the camcorder by detecting a variation in voltage that occurs when the microphone 2 is attached or removed. More specifically, the sensor switch 5 senses that the external microphone plug 3 of the external microphone assembly has been inserted into, or removed from, the external microphone jack 4. As used herein, “to sense a change of microphones” means sensing either the attachment or removal of the external microphone assembly 2 to/from the camcorder 100.

The front microphone selector switching unit 6 (which will be simply referred to herein as the “F switching unit 6”) includes a front left (FL) microphone selector switch 61 and a front right (FR) microphone selector switch 62. In accordance with a control signal supplied from the microcomputer 8, these switches 61 and 62 are selectively turned to form either a signal path a or a signal path b. When the signal path a is selected, the audio signals that have been obtained by the FL and FR microphones 11 and 12 of the internal microphone assembly 1 are passed to the noise filters and A/D converters 9. On the other hand, when the signal path b is selected, the audio signals that have been obtained by the L and R microphones 21 and 22 of the external microphone assembly 2 are passed to the noise filters and A/D converters 9.

The central/rear microphone selector switching unit (which will be simply referred to herein as the “C/R switching unit 7”) includes a central (C) microphone selector switch 71, a rear left (RL) microphone selector switch 72 and a rear right (RR) microphone selector switch 73. In accordance with a control signal supplied from the microcomputer 8, these switches 71, 72 and 73 are selectively turned to form either a signal path a or a signal path b. When the signal path a is selected, the audio signals that have been obtained by the C, RL and RR microphones 13, 14 and 15 of the internal microphone assembly 1 are passed to the noise filters and A/D converters 9. On the other hand, when the signal path b is selected, mute audio signals in the same number of channels as that of the C, RL and RR microphones 13, 14 and 15 are passed to the noise filters and A/D converters 9. It should be noted that the mute audio signals can be generated by grounding the terminals.

The noise filters and A/D converters 9 reduce noise and convert the analog audio signals, which have been supplied from either the internal microphone assembly 1 or the external microphone assembly 2, into digital audio signals.

The signal processor 24 includes an AC-3 codec 10 and an H. 264 codec 23. The AC-3 codec 10 encodes or decodes the audio signals into/from an AC-3 format in 2ch or 5.1ch. Meanwhile, the H. 264 codec 23 encodes or decodes the audio signals supplied from the AC-3 codec 10 and the video signal supplied from the imaging optical system of the camcorder 100. Then, the H. 264 codec 23 writes the video signal, along with the audio signals, on the storage medium 26.

The recording start/stop switch 20 allows the user to start or stop recording.

The microcomputer 8 outputs control signals to various circuits in this camcorder 100 and controls the whole camcorder 100. For example, when the recording start switch is pressed down, the microcomputer 8 instructs the camcorder 100 to start shooting video and also instructs the signal processor 24 to start processing the video signal and audio signals. On being notified by the sensor switch 5 that a variation in voltage has been sensed while the video signal and/or the audio signals are/is being written, the microcomputer 8 senses the external microphone assembly 2 be removed or attached, i.e., a change of microphones for recording. Therefore, the microcomputer 8 outputs control signals to the F switching unit 6 and the C/R switching unit 7 to instruct those units 6 and 7 to change signal paths.

Hereinafter, it will be described how this camcorder 100 operates in recording audio, among other things.

(1) How Camcorder 100 Works when 5ch Internal Microphone Assembly 1 is used at the Start of Recording

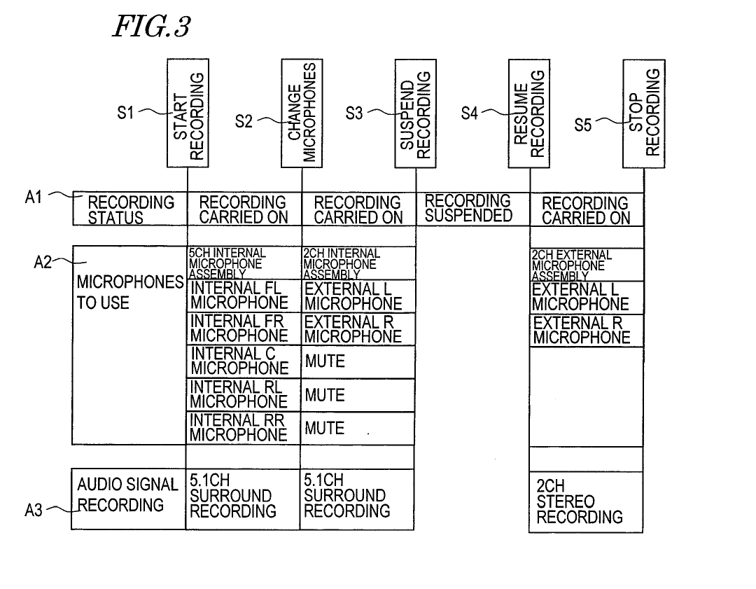

FIG. 3 shows the timings to switch the audio signals when the microphones to use are changed from the 5ch internal microphone assembly into the 2ch external microphone assembly. At the top of FIG. 3, shown are the respective operating timings S1 through S5 for the camcorder 100, under which shown in this order are the recording status A1, the microphones to use A2 and the audio signal recording format A3.

At the top of FIG. 3, S1 indicates the timing to start recording, S2 indicates the timing to change microphones, S3 indicates the timing to stop recording, S4 indicates the timing to resume recording, and S5 indicates the timing to stop recording.

At a timing S1, the recording status A1 indicates that recording is started, the microphones to use A2 are those included in the 5ch internal microphone assembly, and the audio signal recording format A3 says that 5.1ch surround sound audio signals are to be recorded.

While the recording status A1 indicates that recording is being carried on (i.e., while a recording operation is being performed), the attachment of a 2ch external microphone assembly is detected at a timing S2, when the audio signal recording format A3 still indicates that the 5.1ch surround sound recording be continued. At this point in time, however, the microphones to use A2 are changed into those of the 2ch external microphone assembly. Then, the audio signals coming from the L and R microphones of the 2ch external microphone assembly and mute audio signals on the three other channels are used to continue the 5.1ch surround sound recording.

Next, when the recording operation is suspended at a timing S3, the recording status A2 makes a transition to a recording suspended status.

Thereafter, when the camcorder is instructed to resume recording again at a timing T4 while the microphones to use A2 are still those of the 2ch external microphone assembly, the recording operation is started all over again. As a result, the recording status A2 again indicates that recording be carried on. Consequently, the audio signals that have been picked up by the L and R microphones 21 and 22 as the microphones to use A2 are recorded in stereophonic sound.

Hereinafter, it will be described in further detail by reference to those timings S1 through S5 how this camcorder 100 works.

First of all, it will be described how this camcorder 100 responds if the 2ch external microphone assembly is attached while the audio signals that have been picked up by the respective microphones 11 to 15 of the 5ch internal microphone assembly 1 are being recorded. The operation to done in such a situation corresponds to what needs to be done from the timing S1 to after the timing S2 shown in FIG. 3.

At the timing S1 when the user presses down the recording start switch 20 in the recording stopped state, the microcomputer 8 senses, by the level of the input signal supplied from the sensor switch 5, that the 2ch external microphone assembly 2 is currently not connected. Thus, the microcomputer 8 determines that audio signals should be recorded with the 5ch internal microphone assembly 1. Unless the external microphone plug 3 of the 2ch external microphone assembly 2 is inserted into the external microphone jack 4, the microcomputer 8 also senses, by the level of the input signal supplied from the sensor switch 5, that the 2ch external microphone assembly 2 is still not connected yet.

In that case, the microcomputer 8 controls the respective switches 61, 62, 71, 72 and 73 of the F switching unit 6 and the C/R switching unit 7, thereby forming the signal path a. As a result, the audio signals that have been picked up by the FL and FR microphones 11 and 12 are passed to the F switching unit 6. Meanwhile, the audio signals that have been picked up by the C, RL and RR microphones 13, 14 and 15 are passed to the C/R switching unit 7. After that, the respective audio signals are transmitted to the noise filters and A/D converters 9 to have their noise reduced and be A/D converted and then input to the AC-3 codec 10.

If the microcomputer 8 instructs the AC-3 codec 10 to perform 5.1ch AC-3 encoding, the AC-3 codec 10 outputs AC-3 encoded 5.1ch surround sound audio signals to the H. 264 codec 23.

The H. 264 codec 23 performs H. 264 encoding on not only the video signal 11 but also the 5.1ch surround sound audio signals. In the meantime, the microcomputer 8 controls the H. 264 codec 23 such that the H. 264 encoded video and audio signals get stored on the storage medium 26. Under the control of the microcomputer 8, the H. 264 codec 23 writes the video and audio signals, including the 5.1ch surround sound, on the storage medium 26.

Next, it will be described how this camcorder 100 will respond when the external microphone plug 3 of the 2ch external microphone assembly 2 is inserted into the external microphone jack 4 while 5.1ch surround sound is being recorded with the 5ch internal microphone assembly 1.

The microcomputer 8 senses, by the level of the signal supplied from the sensor switch 5, that the 2ch external microphone assembly 2 has been connected.

In that case, the microcomputer 8 controls the respective switches 61, 62, 71, 72 and 73 of the F switching unit 6 and the C/R switching unit 7, thereby forming the signal path b. As a result, the audio signals that have been picked up by the L and R microphones 21 and 22 are passed to the F switching unit 6. Meanwhile, the audio signals on the other channels that have been picked up by the C, RL and RR microphones 13, 14 and 15 are not passed to the noise filters and A/D converters 9. Instead, the C/R switching unit 7 is grounded, thereby transmitting mute audio signals as replacements for those audio signals to the noise filters and A/D converters 9, where the signals have their noise reduced and are A/D converted and then input to the AC-3 codec 10.

Since the recording operation is being carried out, the microcomputer 8 instructs the AC-3 codec 10 to continue AC-3 encoding. In response, the AC-3 codec 10 generates 5.1ch surround sound audio signals and outputs them to the H. 264 codec 23, which in turn performs H. 264 encoding on not only the video signal 11 but also the 5.1ch surround sound audio signals. In the meantime, the microcomputer 8 controls the H. 264 codec 23 such that the H. 264 encoded video and audio signals get stored on the storage medium 26. Under the control of the microcomputer 8, the H. 264 codec 23 writes the video and audio signals, including the 5.1ch surround sound, on the storage medium 26.

As a result, the 5.1ch surround sound recording is continued using the audio signals that have been picked up by the L and R microphones 21 and 22 of the 2ch external microphone assembly 2 and with the audio signals in the other channels muted.

Next, it will be described what processing should be done if the 2ch external microphone assembly 2 were removed while the 5.1ch surround sound is being recorded with the 2ch external microphone assembly 2. Such processing would be performed if at the timing S3 shown in FIG. 3, the recording operation were not suspended but the microphones were changed as at the timing S2, for example.

Suppose the user removes the external microphone plug 3 of the 2ch external microphone assembly 2 from the external microphone jack 4. Then, the microcomputer 8 senses, by the level of the signal supplied from the sensor switch 5, that the 2ch external microphone assembly 2 has been removed, i.e., that the microphones have been changed. In response, the microcomputer 8 controls the respective switches 61, 62, 71, 72 and 73 of the F switching unit 6 and the C/R switching unit 7, thereby forming the signal path a. As a result, the processing steps that have been performed from the timing S1 through the timing S2 shown in FIG. 3 are carried out all over again. Consequently, the camcorder 100 can carry on the 5.1ch surround sound recording using the audio signals that have been picked up by the microphones 11 through 15 of the 5ch internal microphone assembly 1.

Next, it will be described what processing needs to be done if the operation of recording the 5.1ch surround sound that has been picked up by the 2ch external microphone assembly 2 is once suspended and then resumed.

Let's say the user turns the recording start switch 20 at the timing S3 while the recording operation is being carried out. In response, the microcomputer 8 instructs the AC-3 codec 10 to stop AC-3 encoding, and the AC-3 codec 10 follows that instruction. At the same time, the microcomputer also performs a control such that the video and audio signals are not written on the storage medium 26, thereby suspending the 5.1ch surround sound recording.

Next, when the user turns the recording start switch 20 again at the timing S4, the microcomputer 8 will notice that recording does not have to be carried out continuously and also sense, by the level of the signal supplied from the sensor switch 5, that the 2ch external microphone assembly 2 has been connected again. Then, the microcomputer 8 instructs the AC-3 codec 10 to perform AC-3 encoding in two channels, instead of 5.1 channels. Thereafter, the AC-3 codec 10 outputs 2ch stereo sound audio signals to the H. 264 codec 23, which in turn performs H. 264 encoding on not just the video signal 11 but also the 2ch stereo sound audio signals. In the meantime, the microcomputer 8 controls the H. 264 codec 23 such that the H. 264 encoded video and audio signals get stored on the storage medium 26. Under the control of the microcomputer 8, the H. 264 codec 23 writes the video and audio signals, including the 2ch stereo sound, on the storage medium 26.

As described above, if the camcorder 100 once suspends recording the 5.1ch surround sound using the 2ch external microphone assembly 2, then the camcorder 100 will record 2ch stereo sound instead using the 2ch external microphone assembly 2 when instructed to resume recording again after that.

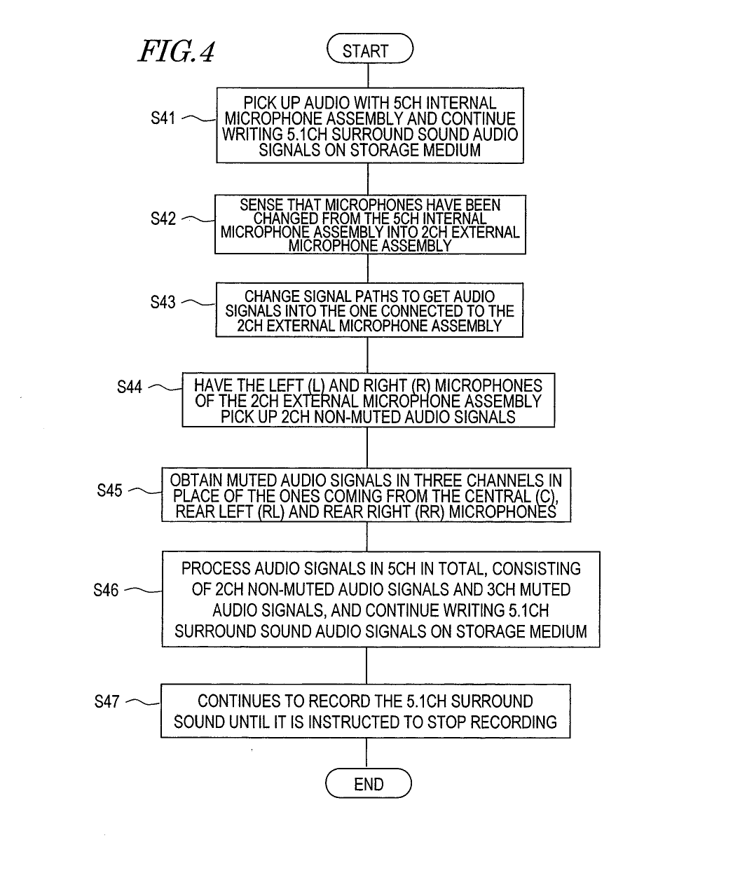

FIG. 4 shows the procedure of the processing steps to be done if the microphones are changed into the 2ch external microphone assembly 2 while audio is being recorded with the 5ch microphone assembly 1. In that case, 5.1ch surround sound audio signals will be recorded.

First, in Step S41, under the control of the microcomputer 8, the camcorder 100 picks up audio with the 5ch internal microphone assembly 1 and continues writing the audio signals on the storage medium 26.

Next, in Step S42, when the sensor switch 5 senses a variation in voltage due to the attachment of the 2ch external microphone assembly 2, the microcomputer 8 senses that the microphones have been changed from the 5ch internal microphone assembly 1 into the 2ch external microphone assembly 2.

Then, in Step S43, the microcomputer 8 changes the signal paths to get the audio signals into the signal path b to transmit the audio signals coming from the 2ch external microphone assembly 2.

As a result, in Step S44, the left (L) and right (R) microphones of the 2ch external microphone assembly pick up 2ch audio signals (non-muted). Then, in the next processing step S45, muted audio signals in three channels are obtained in place of the ones coming from the central (C), rear left (RL) and rear right (RR) microphones.

Subsequently, in Step S46, the noise filters and A/D converters 9, the AC-3 codec 10 and the H. 264 codec 23 process the audio signals in five channels in total, consisting of the 2ch non-muted audio signals and the 3ch muted audio signals, and continue writing the resultant 5.1ch surround sound audio signals on the storage medium 26.

And in Step S47, the camcorder 100 continues to record the 5.1ch surround sound using the 2ch external microphone assembly 2 until it is instructed to stop recording.

According to such processing, the audio signal recording format never changes even when the microphones to use are changed, and therefore, the audio signals can maintain their continuity. On top of that, although non-muted audio signals are recorded in the left (L) and right (R) channels, the audio in the other channels is muted. That is why even though 5.1ch surround sound is actually recorded, the resultant audio would sound as if to be recorded in only two channels. As a result, the audio can be recorded just as requested by the user.

(2) How Camcorder 100 Works when 2ch External Microphone Assembly 1 is used at the Start of Recording

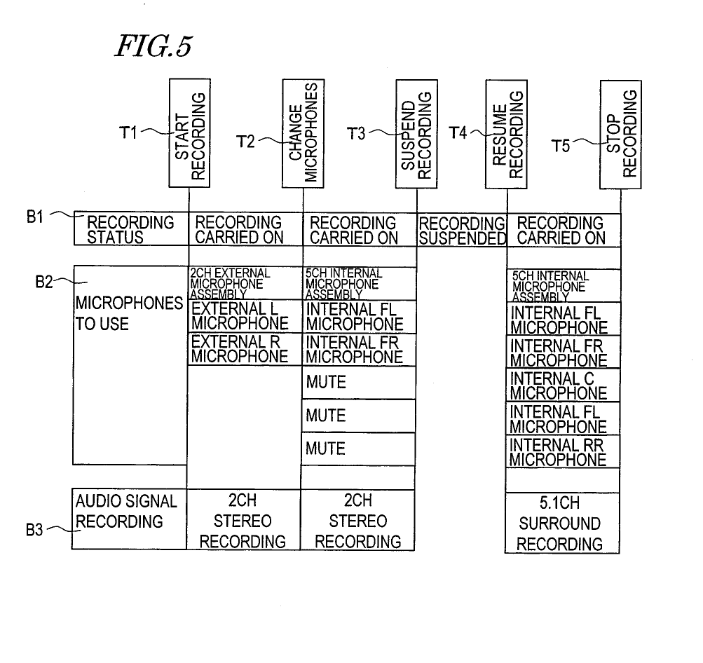

FIG. 5 shows the timings to switch the audio signals when the microphones to use are changed from the 2ch external microphone assembly into the 5ch internal microphone assembly. At the top of FIG. 5, shown are the respective operating timings T1 through T5 for the camcorder 100, under which shown in this order are the recording status B1, the microphones to use B2 and the audio signal recording format B3. FIG. 5 is drawn just like FIG. 3.

While the recording status B1 indicates that recording is being carried on (i.e., while a recording operation is being performed), the removal of the 2ch external microphone assembly 2 is detected at a timing T2, when the microcomputer 8 senses that the microphones to use have been changed. However, as the audio signal recording format B3 says, the camcorder 100 will still continue recording the 2ch stereo sound even after that. At this point in time, however, the microphones to use B2 are changed into those of the 5ch internal microphone assembly. Then, only some of the audio signals coming from the 5ch internal microphone assembly 1 are recorded. Specifically, just the audio signals that have come from the FL and FR microphones 11 and 12 are used but audio signals that have been picked up in the other three channels (with the C, RL, and RR microphones 13, 14 and 15) are not used. As a result, 2ch stereo sound continues to be recorded.

Next, when the recording operation is suspended at a timing T3, the recording status B2 makes a transition to a recording suspended status.

Thereafter, when the camcorder is instructed to resume recording again at a timing T4 while the microphones to use B2 are still those of the 5ch internal microphone assembly 1, the recording operation is started all over again. As a result, the recording status B2 again indicates that recording be carried on. Consequently, all of the audio signals that have been picked up by the 5ch internal microphone assembly 1 that are the microphones to use B2 are recorded in 5.1ch surround sound.

Hereinafter, it will be described in further detail by reference to those timings T1 through T5 how this camcorder 100 works.

At the timing T1 when the user presses down the recording start switch 20 in the recording stopped state, the microcomputer 8 senses, by the level of the input signal supplied from the sensor switch 5, that the 2ch external microphone assembly 2 is currently connected. Thus, the microcomputer 8 determines that audio signals be recorded with the 2ch external microphone assembly 2.

In that case, the microcomputer 8 controls the respective switches 61, 62, 71, 72 and 73 of the F switching unit 6 and the C/R switching unit 7, thereby forming the signal path b. As a result, the audio signals that have been picked up by the L and R microphones 21 and 22 are passed to the noise filters and A/D converters 9 by way of the F switching unit 6. Meanwhile, the audio signals that have come from the other three channels (and have been picked up by the C, RL and RR microphones 13, 14 and 15) are not passed to the noise filters and A/D converters 9. Instead, the C/R switching unit 7 is grounded, thereby sending muted audio signals as replacements for those audio signals to the noise filters and A/D converters 9, where those muted signals have their noise reduced and are A/D converted and then input to the AC-3 codec 10.

If the microcomputer 8 instructs the AC-3 codec 10 to perform AC-3 encoding on the 2ch audio signals, the AC-3 codec 10 outputs AC-3 encoded 2ch stereo sound audio signals to the H. 264 codec 23. But the AC-3 codec 10 does not process the muted audio signals.

The H. 264 codec 23 performs H. 264 encoding on not only the video signal 11 but also the 2ch stereo sound audio signals. In the meantime, the microcomputer 8 controls the H. 264 codec 23 such that the H. 264 encoded video and audio signals get stored on the storage medium 26. Under the control of the microcomputer 8, the H. 264 codec 23 writes the video and audio signals, including the 2ch stereo sound, on the storage medium 26.

Next, it will be described how this camcorder 100 will respond when the external microphone plug 3 of the 2ch external microphone assembly 2 is disconnected from the external microphone jack 4 while 2ch stereo sound is being recorded with the 2ch external microphone assembly 1.

The microcomputer 8 senses, by the level of the signal supplied from the sensor switch 5, that the 2ch external microphone assembly 2 has been removed.

In that case, the microcomputer 8 controls the respective switches 61 and 62 of the F switching unit 6 and the C/R switching unit 7, thereby forming the signal path a. Meanwhile, as for the other switches 71, 72 and 73, the signal path b is maintained.

As a result, the audio signals that have been picked up by the FL and FR microphones 11 and 12 are passed to the F switching unit 6. Meanwhile, the audio signals that have been picked up by the C, RL and RR microphones 13, 14 and 15 are not passed to the noise filters and A/D converters 9. Instead, the C/R switching unit 7 is grounded, thereby transmitting muted audio signals as replacements for those audio signals to the noise filters and A/D converters 9, where the signals have their noise reduced and are A/D converted and then input to the AC-3 codec 10.

Since the recording operation is being carried out, the microcomputer 8 instructs the AC-3 codec 10 to continue AC-3 encoding. In response, the AC-3 codec 10 generates 2ch stereo sound audio signals and outputs them to the H. 264 codec 23.

The H. 264 codec 23 in turn performs H. 264 encoding on not only the video signal 11 but also the 2ch audio signals. In the meantime, the microcomputer 8 controls the H. 264 codec 23 such that the H. 264 encoded video and audio signals get stored on the storage medium 26. Under the control of the microcomputer 8, the H. 264 codec 23 writes the video and audio signals, including the 2ch stereo sound, on the storage medium 26.

As a result, the 2ch stereo sound recording is continued using the audio signals that have been picked up by the FL and FR microphones 11 and 12 of the 5ch internal microphone assembly 1.

Next, it will be described what processing should be done if the 2ch external microphone assembly 2 were attached while the 2ch stereo sound is being recorded with the 5ch internal microphone assembly 1. Such processing would be performed if at the timing T3 shown in FIG. 5, the recording operation were not suspended but the microphones were changed as at the timing T2, for example.

Suppose the user inserts the external microphone plug 3 of the 2ch external microphone assembly 2 into the external microphone jack 4. Then, the microcomputer 8 senses, by the level of the signal supplied from the sensor switch 5, that the 2ch external microphone assembly 2 has been attached, i.e., that the microphones to use have been changed. In response, the microcomputer 8 controls the respective switches 61, 62, 71, 72 and 73 of the F switching unit 6 and the C/R switching unit 7, thereby forming the signal path b. As a result, the processing steps that have been performed from the timing T1 through the timing T2 shown in FIG. 5 are carried out all over again. Consequently, the camcorder 100 can carry on the 2ch stereo sound recording using the audio signals that have been picked up by the 2ch internal microphone assembly 1.

Next, it will be described what processing needs to be done if the operation of recording the 2ch stereo sound that has been picked up by the 5ch internal microphone assembly 1 is once suspended and then resumed.

Let's say the user turns the recording start switch 20 at the timing T3 while the recording operation is being carried out. In response, the microcomputer 8 instructs the AC-3 codec 10 to stop AC-3 encoding, and the AC-3 codec 10 follows that instruction. At the same time, the microcomputer also performs a control such that the video and audio signals are not written on the storage medium 26, thereby suspending the 2ch stereo sound recording.

Next, when the user turns the recording start switch 20 again at the timing T4, the microcomputer 8 will notice that recording does not have to be carried out continuously and also sense, by the level of the signal supplied from the sensor switch 5, that the 2ch external microphone assembly 2 is no longer connected. Then, the microcomputer 8 instructs the AC-3 codec 10 to perform AC-3 encoding in 5.1 channels, instead of two channels. Thereafter, the AC-3 codec 10 outputs 5.1ch surround sound audio signals to the H. 264 codec 23, which in turn performs H. 264 encoding on not just the video signal 11 but also the 5.1ch surround sound audio signals. In the meantime, the microcomputer 8 controls the H. 264 codec 23 such that the H. 264 encoded video and audio signals get stored on the storage medium 26. Under the control of the microcomputer 8, the H. 264 codec 23 writes the video and audio signals, including the 5.1ch surround sound, on the storage medium 26.

As described above, if the camcorder 100 once suspends recording the 2ch sound using the 5ch internal microphone assembly 1, then the camcorder 100 will record 5.1ch surround sound instead using the 5ch internal microphone assembly 1 when instructed to resume recording again after that.

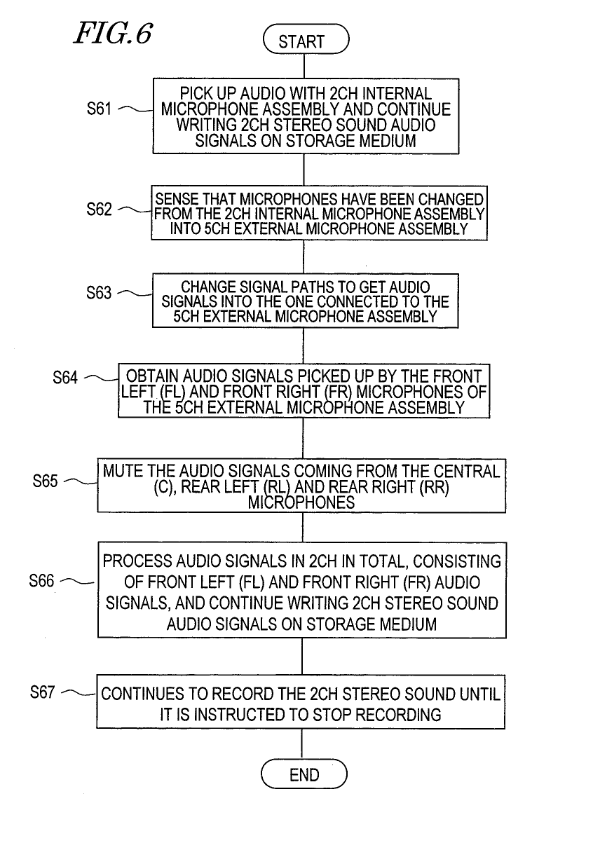

FIG. 6 shows the procedure of the processing steps to be done if the microphones are changed into those of the 5ch internal microphone assembly 1 while audio is being recorded with the 2ch external microphone assembly 2. In that case, 2ch stereo sound audio signals will be recorded.

First, in Step S61, under the control of the microcomputer 8, the camcorder 100 picks up audio with the 2ch external microphone assembly 2 and continues writing the audio signals on the storage medium 26.

Next, in Step S62, when the sensor switch 5 senses a variation in voltage due to the removal of the 2ch external microphone assembly 2, the microcomputer 8 senses that the microphones to use have been changed from the 2ch external microphone assembly 2 into the 5ch internal microphone assembly 1.

Then, in Step S63, the microcomputer 8 changes the signal paths to get the audio signals into the signal path a to transmit the audio signals coming from the 5ch internal microphone assembly 1.

As a result, in Step S44, the front left (FL) and front right (FR) microphones of the 5ch internal microphone assembly 1 pick up 2ch audio signals (non-muted). Then, in the next processing step S45, muted audio signals in three channels are obtained in place of the ones coming from the central (C), rear left (RL) and rear right (RR) microphones.

Subsequently, in Step S66, the noise filters and A/D converters 9, the AC-3 codec 10 and the H. 264 codec 23 process the 2ch non-muted audio signals, and continue writing the resultant 2ch stereo sound audio signals on the storage medium 26.

And in Step S67, the camcorder 100 continues to record the 2ch stereo sound using the 5ch internal microphone assembly 1 until it is instructed to stop recording.

According to such processing, the audio signal recording format never changes even when the microphones to use are changed, and therefore, the audio signals can maintain their continuity.

In the foregoing description of preferred embodiments, the present invention has been described as being implemented as a camcorder.

The procedures of processing shown in FIGS. 4 and 6 can be carried out by making the microcomputer 8 execute a computer program that is made up of various execution codes and stored in a memory (not shown). Such a computer program may be circulated on the market by being stored on a storage medium 26 such as an optical disc like a CD-ROM or a semiconductor memory like a memory card or downloaded over telecommunications lines such as the Internet.

The microcomputer 8 may be implemented as either a DSP by installing the computer program in a semiconductor integrated circuit or a piece of hardware such as a chip circuit or an optical disc controller. Alternatively, the function of the microcomputer 8 could also be performed by getting the computer program, expanded in a memory, executed by a general-purpose processor.

In the preferred embodiments described above, an AC-3 codec is supposed to be used as an audio codec. However, the present invention is in no way limited to those specific preferred embodiments. Alternatively, an AMR codec, an MP3 codec or any other appropriate audio codec may also be used. Furthermore, in the preferred embodiments described above, H. 264 is supposed to be adopted as a video and audio compression method. However, any other appropriate compression method compliant with the MPEG2 or MPEG4 standard, for example, could also be adopted instead.

In the signal processor 24 shown in FIG. 2, the AC-3 codec 10 and the H. 264 codec 23 are implemented as two different circuits. However, this is just an example. Optionally, a single circuit, i.e., the signal processor 24, can perform the functions of both of the AC-3 codec 10 and the H. 264 codec 23 in parallel by itself.

Furthermore, the recorder of the present invention does not have to be a device that is designed to record video such as a camcorder. As long as it can use internal microphones and external microphones, the recorder may also be implemented as a voice recorder, for example.

Furthermore, in the preferred embodiments described above, the number of channels that can be picked up by the internal microphones 1 is supposed to be different from that of channels that can be picked up by the external microphones 2. However, these two numbers may be the same. Even so, the camcorder would work fine with no problem at all.

### INDUSTRIAL APPLICABILITY

The recorder of the present invention may be implemented as a camcorder, for example. If the microphones to obtain audio signals are changed into a different type during a shooting operation, the camcorder can maintain the same audio signal recording format even after the types of microphones to use have been changed and can record audio signals continuously. That is why the present invention can be used effectively as an audio recorder that has audio inputs with multiple different numbers of channels and that needs to get a recording operation done continuously.

More specifically, if the microphones to use are changed into 2ch external microphones while so-called “5.1ch surround sound” audio signals are being recorded using 5ch internal microphones, the camcorder can record the audio signals so that the audio signals do not become discontinuous. Likewise, even if the microphones to use are changed into 5ch internal microphones while audio signals are being recorded using 2ch external microphones, the camcorder can also record the audio signals so that the audio signals do not become discontinuous.

1. A recorder having the ability to record multichannel audio signals by switching one of multiple types of microphones to another,
the multiple types of microphones including a first type of microphones for a first number of channels and a second type of microphones for a second number of channels, either the first or second type of microphones being removable from and attachable to the recorder,
wherein the recorder comprises:
a signal processing section that receives the multichannel audio signals and records the signals on a storage medium; and
a switching control section for controlling a signal path such that on sensing the removable/attachable microphones be removed from or attached to the recorder while audio signals that have been picked up by the first type of microphones are being recorded, audio signals in the same number of channels as the first number, including at least one audio signal that has been picked up by the second type of microphones, are sent to the signal processing section, and
wherein the signal processing section receives the audio signals in the same number of channels as the first number through the signal path and records the audio signals on the storage medium, and
wherein if the first number of channels is greater than the second number of channels,
then the switching control section controls the signal path such that audio signals in the same number of channels as the first number, including the audio signals that have been picked up by the second type of microphones and a mute audio signal, are sent to the signal processing section.

2. The recorder of claim 1, wherein the first type of microphones are built in the recorder and the second type of microphones are connected to, but removable from and attachable to the recorder.

3. A recorder having the ability to record multichannel audio signals by switching one of multiple types of microphones to another,
the multiple types of microphones including a first type of microphones for a first number of channels and a second type of microphones for a second number of channels, either the first or second type of microphones being removable from and attachable to the recorder,
wherein the recorder comprises:
a signal processing section that receives the multichannel audio signals and records the signals on a storage medium; and
a switching control section for controlling a signal path such that on sensing the removable/attachable microphones be removed from or attached to the recorder while audio signals that have been picked up by the first type of microphones are being recorded, audio signals in the same number of channels as the first number, including at least one audio signal that has been picked up by the second type of microphones, are sent to the signal processing section, and
wherein the signal processing section receives the audio signals in the same number of channels as the first number through the signal path and records the audio signals on the storage medium, and
wherein if the first number of channels is smaller than the second number of channels,
then the switching control section controls the signal path such that audio signals in the same number of channels as the first number, which have been selected from the audio signals that have been picked up by the second type of microphones, are sent to the signal processing section.

4. (canceled)

5. The recorder of claim 3, wherein the first type of microphones are connected to, but removable from and attachable to the recorder and the second type of microphones are built in the recorder.

6. The recorder of claim 2, wherein the switching control section senses the second type of microphones be attached to the recorder while the audio signals that have been picked up by the first type of microphones are being recorded.

7. The recorder of claim 5, wherein the switching control section senses the first type of microphones be removed from the recorder while the audio signals that have been picked up by the first type of microphones are being recorded.

8. The recorder of claim 1, wherein after audio has stopped being recorded,
the switching control section controls the signal path such that the audio signals in the second number of channels, which have been picked up by the second type of microphones, are sent to the signal processing section.

9. A recording method to be carried out with a recorder having the ability to record multichannel audio signals by switching one of multiple types of microphones to another,
the multiple types of microphones including a first type of microphones for a first number of channels and a second type of microphones for a second number of channels, one of the first and second types of microphones being removable from and attachable to the recorder,
wherein the method comprises the steps of:
receiving the multichannel audio signals and recording the signals on a storage medium;
sensing the removable and attachable microphones be removed from, or attached to, the recorder while audio signals that have been picked up by the first type of microphones are being recorded;
controlling a signal path on sensing the microphones be removed or attached to output audio signals in the same number of channels as the first number including at least one audio signal that has been picked up by the second type of microphones; and
recording the audio signals in the same number of channels as the first number on the storage medium, and
wherein if the first number of channels is greater than the second number of channels,
then the step of controlling a signal path includes controlling the signal path such that audio signals in the same number of channels as the first number, including the audio signals that have been picked up by the second type of microphones and a mute audio signal, are output.
